(19) United States
(12) Patent Application Publication
(10) Pub. No.: US 2007/0111601 A1
(43) Pub. Date: May 17, 2007

(54) Connector and connecting module

(75) Inventors: Ru-Kuen Huang, Taoyuan Hsien (TW); Yu-Yuan Tai, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/385,787

(22) Filed: Mar. 22, 2006

(30) Foreign Application Priority Data
Nov. 11, 2005 (TW) 094139629

(51) Int. Cl. H01R 13/66

(52) U.S. Cl. 439/620.1

(57) ABSTRACT

A connector, which is easily assembled and has a fine grounding function, includes a case, a circuit board and a capacitor. The case has a grounding portion. The circuit board is disposed in the case. The capacitor has a first pin and a second pin electrically connected with the circuit board and the grounding portion, respectively.

### BACKGROUND OF THE INVENTION

1. Field of Invention

The invention relates to a connector and a connecting module and, in particular, to a connector and a connecting module applied in a communication system.

2. Related Art

As shown in FIG. 1, a conventional connector 1 includes a capacitor 11, a circuit board 12, a front steel case (not shown), and a back steel case 13. The capacitor 11 has a first pin 111 and a second pin 112. The first pin 111 of the capacitor 11 is usually welded to the circuit board 12, and the second pin 112 passes through a hole 131 formed on the back steel case 13 of the connector 1. The second pin 112 is welded to the back steel case 13 for grounding. In general, the second pin 112 is protruded from the surface of the back steel case 13 by about 0.4 mm to 0.6 mm. After the welding process, a hemispherical solder ball 132 is formed on the hole 131 of the back steel case 13, as shown in FIG. 2. In this case, two manual welding processes are needed for the second pin 112 which passes through the hole 131 of the back steel case 13 to connect with the back steel case 13. Besides, it is difficult for the second pin 112 to pass through the back steel case 13. Therefore, this kind of connector needs complex manufacturing processes and thus increases the labor and time cost.

As shown in FIG. 3, another conventional connector 2 includes a capacitor 21, a circuit board 22, and a steel case 23. The capacitor 21 is mounted on the circuit board 22 by surface mount technology (SMT). The steel case 23 of the connector 2 is punched to form a holding member 231 for holding a grounding terminal 221 of the circuit board 22, whereby the circuit board 22 can be grounded. However, since the thickness of the steel case 23 is about 0.2 mm to 0.3 mm and is made of stainless steel or copper, the holding member 231 has poor elasticity to hold the circuit board 22. Thus, it can not strongly hold the circuit board 22. Besides, the contact area of the circuit board 22 and the holding member 231 is easily rusted. If the holding member 231 can not strongly hold the circuit board 22, the grounding function will be serious affected, which will result in the poor reliability and efficiency.

It is therefore an important subject of the invention to provide a connector and a connecting module that can be simply manufactured and has good grounding function.

### SUMMARY OF THE INVENTION

In view of the foregoing, the invention is to provide a connector and a connecting module that can be simply manufactured, and has good grounding function.

To achieve the above, a connecting module of the invention includes a case, at least one circuit board, and at least one capacitor. The case has at least one grounding portion, and the circuit board is disposed in the case. The capacitor has a first pin and a second pin, which are electrically connected with the circuit board and the grounding portion, respectively.

To achieve the above, a connector of the invention includes a case, a circuit board, and a capacitor. The case has at least one grounding portion, and the circuit board is disposed in the case. The capacitor has a first pin and a second pin, which are electrically connected with the circuit board and the grounding portion, respectively.

Specifically, the second pin of the capacitor can be strongly fixed to and electrically connected with the grounding portion by welding or winding. Compared with the prior art, the capacitor of the invention is unnecessary to pass through the case for welding but still strongly fixed to the ground portion. Thus, the manufacturing processes become simpler. Also, since the contact portion of the second pin and grounding portion is inside the case, the exterior usable space is increased. Moreover, the pin of the capacitor may be electrically connected with the grounding portion by winding and, then, welding so as to ensure the grounding function. Accordingly, the reliability of the connector and the connecting module is further enhanced.

### BRIEF DESCRIPTION OF THE DRAWINGS

The invention will become more fully understood from the detailed description given herein below illustration only, and thus is not limitative of the present invention, and wherein:

FIG. 1 is a schematic view of a conventional connector;

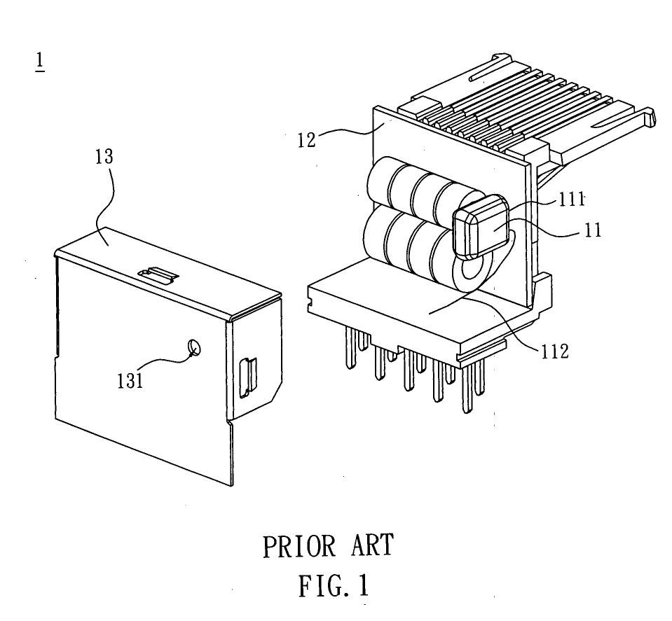

FIG. 2 is an assembling diagram of the conventional connector in FIG. 1;

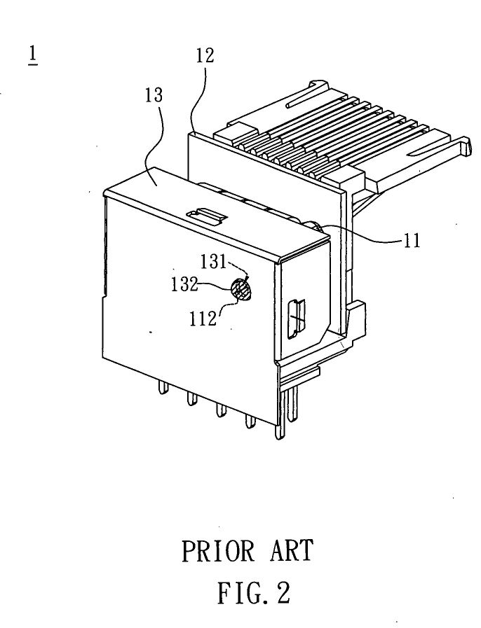

FIG. 3 is a schematic view of another conventional connector;

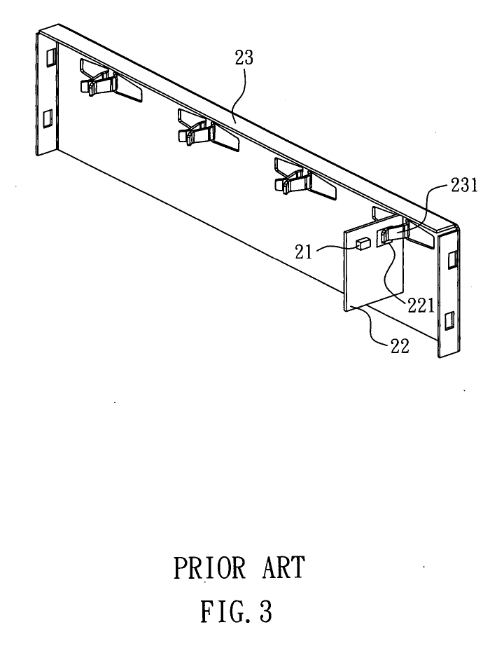

FIG. 4 is a schematic view of a connector according to a preferred embodiment of the invention; and

FIG. 5 is a schematic view of a connecting module according to a preferred embodiment of the invention.

### DETAILED DESCRIPTION OF THE INVENTION

The present invention will be apparent from the following detailed description, which proceeds with reference to the accompanying drawings, wherein the same references relate to the same elements.

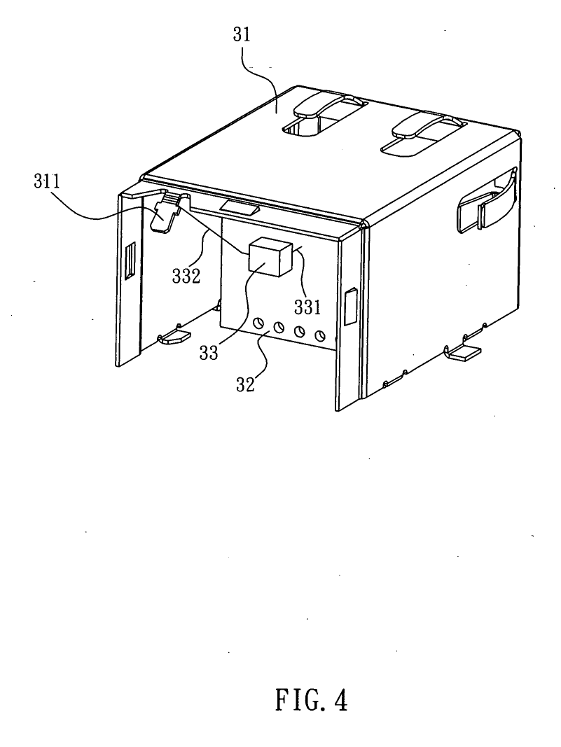

With reference to FIG. 4, a connector 3 according to a preferred embodiment of the. invention includes a case 31, a circuit board 32, and a capacitor 33. Herein, an RJ-45 connector is taken as an example. Of course, the connector can also be any kind of connector in a communication system, such as an RJ-11 connector or an RJ-12 connector.

The case 31 has a grounding portion 311, which is, for example but not limited to, an elastic member. The case 31 and the grounding portion 311 can be integrally formed as a single unit by punching or stamping. The case 31 and the grounding portion 311 are made of an electrically conductive material such as a metal or an alloy. Besides, the case 31 can also be made of a rigid material. In the embodiment, the circuit board 32 is disposed in the case 31.

The capacitor 33 has a first pin 331 and a second pin 332. In this embodiment, the capacitor 33 is, for example but not limited to, a high-voltage capacitor. The first pin 331 and the second pin 332 are electrically connected with the circuit board 32 and the grounding portion 311, respectively, by any possible connecting method. The first pin 331 can be electrically connected with the circuit board 32 by surface mount technology (SMT), and the second pin 332 can be electrically connect with the grounding portion 311 by winding or welding (not shown).

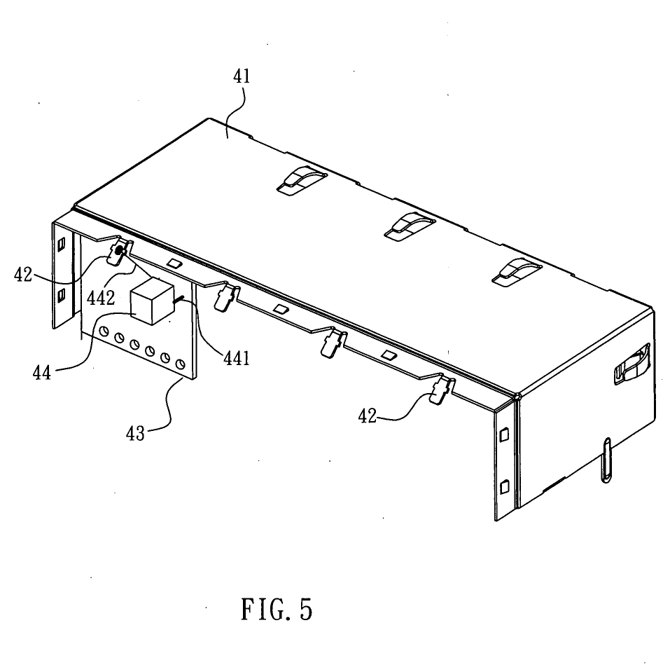

Referring to FIG. 5, a connecting module 4 of the present invention includes a case 41, at least one circuit board 43, and at least one capacitor 44. Herein, an RJ-45 connecting module is taken as an example. Of course, the connecting module can also be an RJ-11 connecting module or an RJ-12 connecting module.

The case 41 has at least one grounding portion 42 such as an elastic member. The case 41 and the grounding portion 42 are connected with each other by any available connection method and they can be integrally formed as a single unit by punching or stamping. The case 41 and the grounding portion 42 are made of, but are not limited to, an electrically conductive material such as a metal or an alloy. Besides, the case 41 can also be made of a rigid material. In the embodiment, the circuit board 43 is disposed in the case 41.

The capacitor 44 has a first pin 441 and a second pin 442. In this embodiment, the capacitor 44 is a high-voltage capacitor. The first pin 441 and the second pin 442 are electrically connected with the circuit board 43 and the grounding portion 42, respectively. The first pin 441 can be electrically connected with the circuit board 43 by surface mount technology (SMT), and the second pin 442 can be electrically connected with the grounding portion 42 by welding or winding (not shown).

As mentioned above, the connector and connecting module of the invention has a grounding portion formed on the case, and the pin of the capacitor is strongly fixed to the grounding portion by welding or winding. Compared with the prior art, the capacitor of the invention is unnecessary to pass through the case for welding but still is strongly fixed to and electrically connected with the ground portion. Thus, the manufacturing processes become simpler. Also, since the contact portion of the second pin and grounding portion is inside the case, the exterior usable space is increased. Moreover, the pin of the capacitor can be electrically connected with the grounding portion by winding and soldering or welding so as to ensure the grounding function. Accordingly, the reliability of the connector and the connecting module is further enhanced.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

1. A connecting module comprising:
a case having at least one grounding portion;
at least one circuit board disposed in the case; and
at least one capacitor having a first pin and a second pin, wherein the first pin is electrically connected with the circuit board and the second pin is directly electrically connected with the grounding portion.

2. The connecting module of claim 1, wherein the case and the grounding portion are integrally formed as a single unit by punching or stamping.

3. The connecting module of claim 1, wherein the case and the grounding portion are made of a metal, an alloy or an electrically conductive material.

4. The connecting module of claim 1, wherein the case is made of a rigid material.

5. The connecting module of claim 1, wherein the first pin and the circuit board are electrically connected by surface mount technology (SMT).

6. The connecting module of claim 1, wherein the grounding portion is an elastic member.

7. The connecting module of claim 1, wherein the capacitor is a high-voltage capacitor.

8. The connecting module of claim 1, wherein the second pin of the capacitor is electrically connected with the grounding portion by welding, soldering or winding.

9. The connecting module of claim 1, which is an RJ-11, RJ-12, or RJ-45 connecting module.

10. A connector comprising:
a case having at least one grounding portion;
a circuit board disposed in the case; and
a capacitor having a first pin and a second pin, wherein the first pin is electrically connected with the circuit board and the second pin is directly electrically connected with the grounding portion.

11. The connector of claim 10, wherein the case and the grounding portion are integrally formed as a single unit by punching or stamping.

12. The connector of claim 10, wherein the case and the grounding portion are made of a metal, an alloy or an electrically conductive material.

13. The connector of claim 10, wherein the case is made of a rigid material.

14. The connector of claim 10, wherein the first pin and the circuit board are electrically connected by surface mount technology (SMT).

15. The connector of claim 10, wherein the grounding portion is an elastic member.

16. The connector of claim 10, wherein the capacitor is a high-voltage capacitor.

17. The connector of claim 10, wherein the second pin of the capacitor is electrically connected with the grounding portion by welding, soldering or winding.

18. The connector of claim 10, which is RJ-11, RJ-12, or RJ-45 connector.
